(19) United States
(12) Patent Application Publication
(10) Pub. No.: US 2023/0417574 A1
(43) Pub. Date: Dec. 28, 2023

(54) INFORMATION PROCESSING APPARATUS, INFORMATION PROCESSING SYSTEM, AND INFORMATION PROCESSING METHOD

(71) Applicant: Sony Group Corporation, Tokyo (JP)

(72) Inventors: Kentaro Kimura, Tokyo (JP); Yasuyuki Koga, Kanagawa (JP)

(73) Assignee: Sony Group Corporation, Tokyo (JP)

(21) Appl. No.: 18/265,236

(22) PCT Filed: Nov. 30, 2021
(86) PCT No.: PCT/JP2021/043784

§ 371 Date: Jun. 2, 2023

(30) Foreign Application Priority Data
Dec. 10, 2020 (JP) 2020-205394

(51) Int. Cl. G01C 21/00; G01C 21/36

(52) U.S. Cl. CPC G01C 21/3889; G01C 21/3617

(57) ABSTRACT

An information processing apparatus (1) according to the present disclosure includes a storage unit (2), a position acquisition unit (32), a state acquisition unit (33), a prediction unit (34), and a distribution unit (35). The storage unit (2) stores destination information (21) in which position information of a destination is associated with content provided from a terminal device (10) of a user to the user at the destination. The position acquisition unit (32) acquires position information of the user from the terminal device (10). The state acquisition unit (33) acquires state information of the user from the terminal device (10). The prediction unit (34) distributes the content to be provided to the user at the destination predicted and causes the terminal device (10) to pre-download the content before the user arrives at the destination predicted.

### FIELD

The present disclosure relates to an information processing apparatus, an information processing system, and an information processing method.

### BACKGROUND

There is an information providing system that causes a mobile object to acquire information highly likely to be required by a user during movement, having been selected on the basis of the position of the mobile object, to reduce an amount of data for communication with the mobile object (e.g., see Patent Literature 1).

### CITATION LIST

### Patent Literature

Patent Literature 1: JP 2001-108477 A

### SUMMARY

### Technical Problem

However, it is difficult to estimate where the user will go thereafter only from the position of the mobile object, and thus, it is impossible to accurately select the information required by the user, the mobile object may be caused to acquire useless information, and the amount of data for communication may not be reduced.

Therefore, the present disclosure proposes an information processing apparatus, an information processing system, and an information processing method that are configured to accurately select information necessary for a user and provide the information to the user to reduce the amount of data for communication.

### Solution to Problem

According to the present disclosure, an information processing apparatus is provided. The information processing apparatus includes a storage unit, a position acquisition unit, a state acquisition unit, a prediction unit, and a distribution unit. The storage unit stores destination information in which position information of a destination is associated with content provided from a terminal device of a user to the user at the destination. The position acquisition unit acquires position information of the user from the terminal device. The state acquisition unit acquires state information of the user from the terminal device. The prediction unit predicts the destination as a destination of the user, based on the position information of the user and the state information of the user. The distribution unit distributes the content to be provided to the user at the destination predicted to the terminal device and causes the terminal device to pre-download the content, before the user arrives at the destination predicted.

### BRIEF DESCRIPTION OF DRAWINGS

FIG. 1 is a diagram illustrating an overview of an information processing method according to a first embodiment.

FIG. 2 is a diagram illustrating an exemplary configuration of a terminal device according to the first embodiment.

FIG. 3 is a diagram illustrating an exemplary configuration of an information processing apparatus according to the first embodiment.

FIG. 4 is a diagram illustrating operations of the information processing apparatus according to the first embodiment.

FIG. 5 is a diagram illustrating a specific example of a method for selection of content according to the first embodiment.

FIG. 6 is a diagram illustrating a specific example of the method for selection of content according to the first embodiment.

FIG. 7 is a diagram illustrating exemplary distribution of content according to the first embodiment.

FIG. 8 is a flowchart illustrating processing performed by the information processing apparatus according to the first embodiment.

FIG. 9 is a diagram illustrating an exemplary configuration of an information processing apparatus according to a second embodiment.

FIG. 10 is a diagram illustrating operations of the information processing apparatus according to the second embodiment.

FIG. 11 is a flowchart illustrating processing performed by the information processing apparatus according to the second embodiment.

### DESCRIPTION OF EMBODIMENTS

Embodiments of the present disclosure will be described in detail below with reference to the drawings. Note that in the following embodiments, the same portions are denoted by the same reference numerals or symbols, and repetitive description thereof will be omitted.

### 1. First Embodiment

[1.1. Overview of Information Processing Method According to First Embodiment]

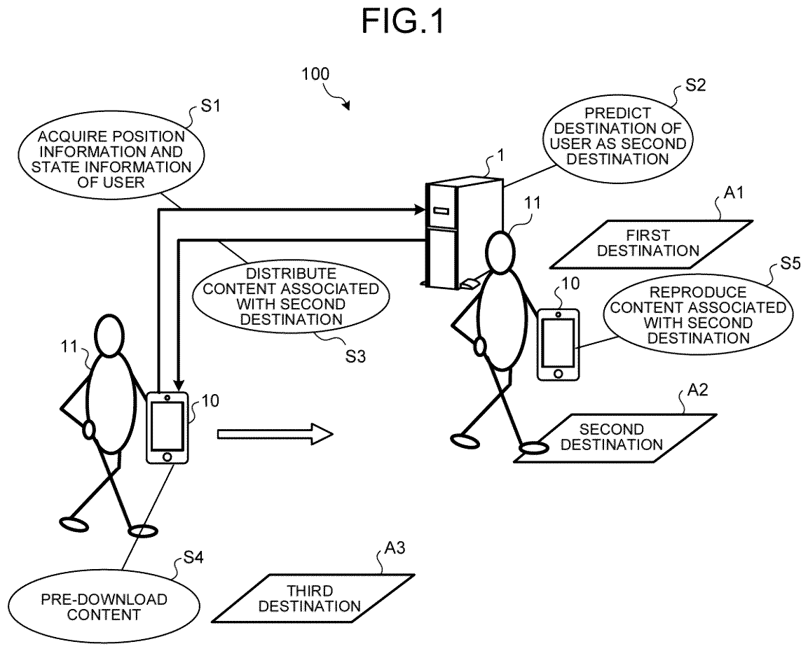

FIG. 1 is a diagram illustrating an overview of an information processing method according to a first embodiment. As illustrated in FIG. 1, an information processing system 100 according to the embodiment includes an information processing apparatus 1 and a terminal device 10. The information processing system 100 is a server device that is configured to perform wireless communication with the terminal device 10. The terminal device 10 is, for example, a smartphone carried by a user 11. The terminal device 10 may be a portable game machine having a communication function or tablet mobile terminal.

The information processing apparatus 1 stores content provided from the terminal device 10 to the user 11, in each of a plurality of destinations that can be a destination of the user 11 who moves. The information processing apparatus 1 distributes the content to the terminal device 10 and causes the terminal device 10 to pre-download the content. When the user 11 arrives at a destination, the terminal device 10 provides the user 11 with the content associated with the destination.

The information processing system 100 can be applied to various augmented reality (AR) entertainment. For example, according to the information processing system 100, the user 11 moving in a theme park can be provided with content related to each of facilities to which the user 11 goes. Furthermore, according to the information processing system 100, the user 11 of an AR game using a street or a building in a real world can be provided with content associated with each of areas where the user 11 goes.

Here, if the information processing apparatus 1 distributes all the content to the terminal device 10 at a time in advance and causes the terminal device 10 to pre-download the content, a long time is required to pre-download. Meanwhile, if the information processing apparatus 1 causes the user 11 who has been arrived at a destination to pre-download the content, it is too late to download the content, achieving no real-time capability.

Therefore, there is an information providing system that selects the content on the basis of the position of the user 11 during movement and then provides the selected content to the user 11. However, in this system, it is difficult to estimate where the user 11 will go thereafter only from the position of the user 11, and thus, it is impossible to accurately select content required by the user 11. Therefore, the terminal device 10 may acquire useless information, preventing the reduction of an amount of data for communication.

Therefore, the present disclosure proposes an information processing apparatus 1, an information processing system 100, and an information processing method that are configured to accurately select information necessary for a user 11 and provide the information to the user 11 to reduce the amount of data for communication.

As illustrated in FIG. 1, in the information processing system 100, the information processing apparatus 1 first acquires position information of the user 11 who is moving and state information of the user 11, from the terminal device 10 (Step S1). At this time, near the user 11, there are a first destination A1, a second destination A2, and a third destination A3 that are candidates for the destination of the user 11. Therefore, it is difficult for the information processing apparatus 1 to estimate where the destination of the user 11 is among the first destination A1, the second destination A2, and the third destination A3, only from the position information of the user 11.

Therefore, the information processing apparatus 1 acquires the state information of the user 11 in addition to the position information of the user 11. The state information includes, for example, a moving direction, moving speed, moving acceleration, and the like of the user 11 (see a white arrow illustrated in FIG. 1). Therefore, the information processing apparatus 1 predicts the destination of the user 11 as the second destination A2, from the position information and state information of the user 11 (Step S2). In this manner, the information processing apparatus 1 is allowed to readily estimate the destination of the user 11.

Then, the information processing apparatus 1 distributes content associated with the second destination A2 to the terminal device 10 (Step S3). At this time, the information processing apparatus 1 does not distribute content associated with the first destination A1 and the third destination A3 that are in the vicinity of the user 11 when the position information is acquired, to the terminal device 10. Therefore, the information processing apparatus 1 is operable to reduce the amount of data for communication.

The terminal device 10 pre-downloads the content distributed from the information processing apparatus 1 (Step S4). Then, when the user 11 arrives at the second destination A2, the terminal device 10 reproduces the content associated with the second destination A2 (Step S5). At this time, the terminal device 10 reproducing the pre-downloaded content can achieve the real-time capability. The terminal device 10 and the information processing apparatus 1 according to the present disclosure will be specifically described below.

Hereinafter, the content pre-downloaded by the terminal device 10 being sound information will be described, but the content may be information other than the sound information. For example, the content may be moving image data, still image data, 3D model data, and motion data. In addition, the content may be reverberation data based on a room impulse response at a destination, dictionary data about an agent character, a new scenario sequence, and map data. Here, the scenario sequence is data about a real or virtual destination that is the destination of the user.

[1.2. Exemplary Configuration of Terminal Device According to First Embodiment]

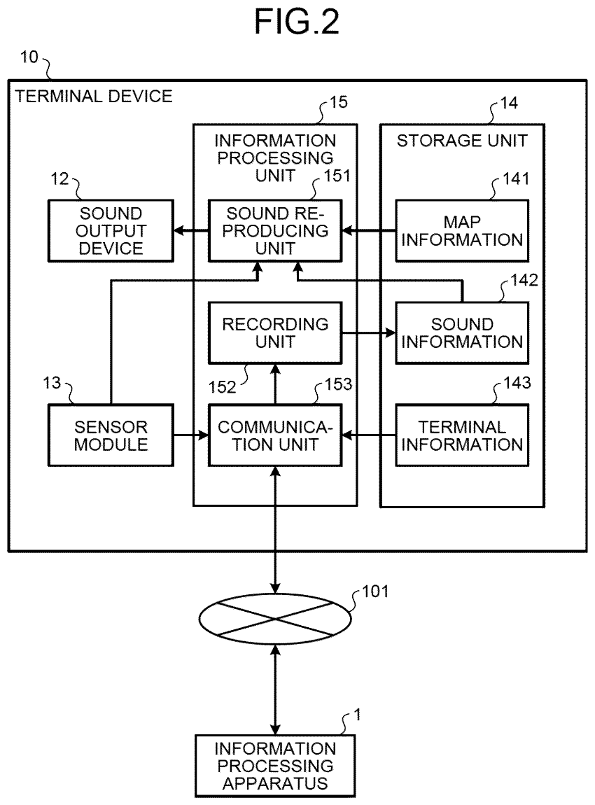

FIG. 2 is a diagram illustrating an exemplary configuration of the terminal device according to the first embodiment. As illustrated in FIG. 2, the terminal device 10 is wirelessly communicably connected to the information processing apparatus 1 via a communication network 101 such as the Internet. The terminal device 10 includes a sound output unit 12, a sensor module 13, a storage unit 14, and an information processing unit 15. Although not illustrated here, the terminal device 10 also includes a touch panel display that serves as a display operation unit.

The sound output unit 12 is, for example, a speaker. The sound output unit 12 outputs the sound information input from the information processing unit 15. The sound output unit 12 may be, for example, an interface that outputs the sound information to an earphone or a wireless earphone.

The sensor module 13 includes, for example, a global positioning system (GPS) positioning module, an inertial measurement unit (IMU) sensor that is an inertial measurement device, and the like. The GPD positioning module measures the position of the terminal device 10 and outputs the measured position to the information processing unit 15. The IMU sensor detects the speed, acceleration, angular speed, and moving direction of the terminal device 10 and outputs the detected results to the information processing unit 15.

The storage unit 14 is, for example, an information storage device such as a data flash, and stores map information 141, sound information 142, and terminal information 143. The map information 141 includes real world map information and virtual space map information. The sound information 142 is content pre-downloaded from the information processing apparatus 1. The terminal information 143 includes information indicating a state of the communication speed of the terminal device 10, information indicating a state of holding the sound information 142, information indicating the free space of the storage unit 14, and the like.

The information processing unit 15 includes various circuits such as a microcomputer including a central processing unit (CPU), a read only memory (ROM), a random access memory (RAM), and the like and a processor. The information processing unit 15 includes a sound reproducing unit 151, a recording unit 152, and a communication unit 153 that function by executing programs stored in the ROM by the CPU with the RAM as a work area.

Note that some or all of the sound reproducing unit 151, the recording unit 152, and the communication unit 153 included in the information processing unit 15 may include hardware such as an application specific integrated circuit (ASIC) or a field programmable gate array (FPGA).

The sound reproducing unit 151, the recording unit 152, and the communication unit 153 that are included in the information processing unit 15 each implement or execute the operations of information processing which are described below. Note that the internal configuration of the information processing unit 15 is not limited to the configuration illustrated in FIG. 2, and may have another configuration as long as information processing described later is performed.

The communication unit 153 transmits the position of the terminal device 10 measured by the sensor module 13 to the information processing apparatus 1, as the position information of the user 11. The communication unit 153 transmits the terminal information 143 to the information processing apparatus 1. The communication unit 153 transmits the speed, acceleration, angular speed, and moving direction of the terminal device 10 detected by the sensor module 13, to the information processing apparatus 1, as the state information of the user 11.

Furthermore, the communication unit 153 receives the sound information 142 distributed from the information processing apparatus 1 and outputs the sound information to the recording unit 152. The recording unit 152 causes the storage unit 14 to store the sound information 142 input from the communication unit 153 to pre-download the sound information 142.

The sound reproducing unit 151 determines whether the terminal device 10 has arrived at a destination (sequence) on a map, on the basis of the position of the terminal device 10 input from the sensor module 13 and the map information 141. When it is determined that the terminal device 10 has arrived at the destination (sequence) on the map, the sound reproducing unit 151 reads the sound information 142 associated with the destination at which the terminal device 10 arrives, from the storage unit 14, outputs the sound information to the sound output unit 12, and reproduces the sound information.

[1.3. Exemplary Configuration of Information Processing Apparatus According to First Embodiment]

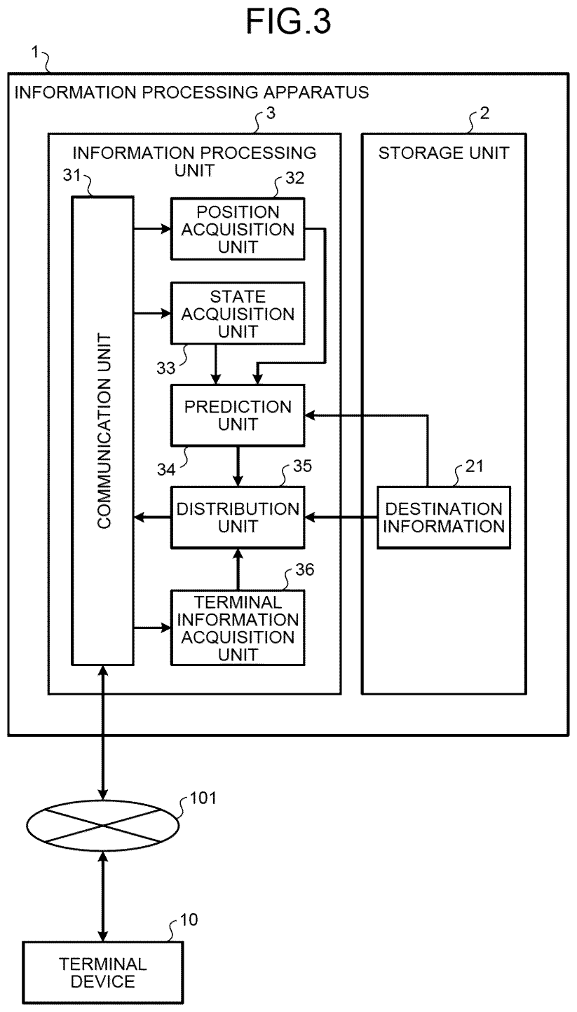

FIG. 3 is a diagram illustrating an exemplary configuration of the information processing apparatus according to the first embodiment. As illustrated in FIG. 3, the information processing apparatus 1 is wirelessly communicably connected to the terminal device 10 via the communication network 101. The information processing apparatus 1 includes a storage unit 2 and an information processing unit 3.

The storage unit 2 is, for example, an information storage device such as a data flash, and stores destination information 21. The destination information 21 is information in which position information of the plurality of destinations that are candidates for the destination of the user 11 is associated with the sound information 142 provided at the destinations, from the terminal device 10 of the user 11 to the user.

The destination information 21 includes a map including the plurality of destinations and a sequence structure. Here, the map is real world map information or virtual space map information. The sequence structure is information indicating arrangement positions of places (sequences) that can be destinations of the user 11 on the map.

The information processing unit 3 includes various circuits such as a microcomputer including CPU, ROM, RAM, and the like and a processor. The information processing unit 3 includes a plurality of processing units that function by executing programs stored in the ROM by the CPU with the RAM as a work area. In one example, the information processing unit 3 includes a communication unit 31, a position acquisition unit 32, a state acquisition unit 33, a prediction unit 34, a distribution unit 35, and a terminal information acquisition unit 36.

Note that some or all of the communication unit 31, the position acquisition unit 32, the state acquisition unit 33, the prediction unit 34, the distribution unit 35, and the terminal information acquisition unit 36 included in the information processing unit 3 may include hardware such as ASIC or FPGA.

The communication unit 31, the position acquisition unit 32, the state acquisition unit 33, the prediction unit 34, the distribution unit 35, and the terminal information acquisition unit 36 that are included in the information processing unit 3 each implement or execute the operations of information processing which are described below. Note that the internal configuration of the information processing unit 3 is not limited to the configuration illustrated in FIG. 3, and may have another configuration as long as information processing described later is performed.

The communication unit 31 is a communication interface that transmits and receives various information to and from the terminal device 10 via the communication network 101. The position acquisition unit 32 acquires the position information of the user 11 from the terminal device 10 via the communication unit 31 and the communication network 101, and outputs the position information to the prediction unit 34. The state acquisition unit 33 acquires the state information of the user 11 from the terminal device 10 via the communication unit 31 and the communication network 101, and outputs the state information to the prediction unit 34.

The prediction unit 34 predicts a destination as the destination of the user, on the basis of the input position information and state information of the user 11, and the position information of the destinations included in the destination information 21, and outputs the predicted destination to the distribution unit 35. The prediction unit 34 also outputs the current position information of the user 11 to the distribution unit 35.

The terminal information acquisition unit 36 acquires the terminal information 143 about the terminal device 10 from the terminal device 10 via the communication unit 31 and the communication network 101, and outputs the terminal information to the distribution unit 35. As described above, the terminal information 143 includes the information indicating a state of the communication speed of the terminal device 10, the information indicating a state of holding the sound information 142, the information indicating the free space of the storage unit 14, and the like.

Before the user 11 arrives at the destination predicted by the prediction unit 34, the distribution unit 35 distributes the sound information 142 to be provided to the user 11 in the predicted destination, to the terminal device 10 and causes the terminal device 10 to pre-download the sound information 142.

At this time, the distribution unit 35 sets the type of pre-downloading according to the terminal information 143 about the terminal device 10 and the like, and distributes the sound information 142. Next, the operations of the information processing apparatus 1 will be described more specifically.

[1.4. Operations of Information Processing Apparatus According to First Embodiment]

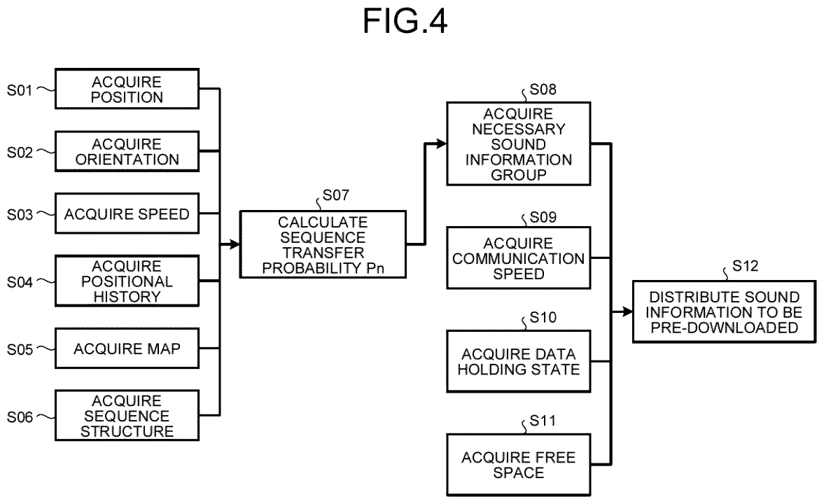

FIG. 4 is a diagram illustrating operations of the information processing apparatus according to the first embodiment. As illustrated in FIG. 3, the position acquisition unit 32 acquires the position of the user 11 (Step S01). The state acquisition unit 33 acquires the moving orientation (direction) of the user 11 (Step S02), and acquires the moving speed of the user 11 (Step S03).

Furthermore, the position acquisition unit 32 acquires a positional history of the user 11 (Step S04). The prediction unit 34 acquires the map (Step S05) and acquires the sequence structure (Step S06). Thereafter, the prediction unit 34 calculates a sequence transfer probability Pn (Step S07). The sequence transfer probability Pn indicates a probability that the user 11 may go to a certain destination in the future.

For example, the prediction unit 34 predicts the plurality of destinations that may be the destination of the user 11, from the current position of the user 11, the positional history, the map, and the sequence structure. Then, the prediction unit 34 calculates the sequence transfer probability Pn, which indicates a probability that the user 11 may go to each destination, for each of the plurality of destinations, based on the positional relationship between the user 11 and each destination, and the orientation and speed of the user. The sequence transfer probability Pn shows a higher probability, when the destination is closer to the user 11, the destination is closer to the moving direction of the user 11, and the destination to which the user 11 has a higher moving speed.

The distribution unit 35 acquires a necessary sound information group representing the candidates for the sound information 142 to be distributed to the terminal device 10, from the destination information 21 (Step S08). Then, the distribution unit 35 sets the sound information 142 to be distributed to the terminal device 10 according to the sequence transfer probability Pn. The distribution unit 35 sets a higher priority to the sound information 142 having a higher sequence transfer probability Pn.

Thereafter, the terminal information acquisition unit 36 acquires the communication speed of the terminal device 10 (Step S09), acquires a data holding state of the terminal device 10 (Step S10), and acquires the free space of the terminal device 10 (Step S11).

The distribution unit 35 sets the type of pre-downloading according to the communication speed, data holding state, and free space of the terminal device 10. At this time, the distribution unit 35 sets, as the type of pre-downloading, at least one of the communication speed at which the sound information 142 is caused to be pre-downloaded and the quality of the sound information 142.

For example, the distribution unit 35 sets the terminal device 10 to pre-download the sound information 142 at high speed in a manner that the higher the communication speed of the terminal device 10, the higher the quality of the sound information 142. The distribution unit 35 sets the terminal device 10 to pre-download the sound information 142 at high speed in a manner that the smaller the data holding amount of the sound information 142 of the terminal device 10, the higher the quality of the sound information 142. The distribution unit 35 sets the terminal device 10 to pre-download the sound information 142 at high speed in a manner that the larger the free space in the storage unit 14 of the terminal device 10, the higher the quality of the sound information 142.

Furthermore, the distribution unit 35 sets the type of pre-downloading according to the sequence transfer probability Pn. Specifically, the distribution unit 35 performs setting so that the sound information 142 associated with a destination to which the user 11 is more likely to go is pre-downloaded at higher speed, with higher quality.

Then, the distribution unit 35 distributes the sound information 142 to be pre-downloaded to the terminal device 10 according to the set type of pre-downloading, and causes the terminal device 10 to pre-download the sound information 142 (Step S12). At this time, the distribution unit 35 distributes pieces of the sound information 142 having a sequence transfer probability Pn equal to or larger than a certain value, in descending order of the set priority.

When a distance from the user 11 to the destination is equal to or less than a predetermined distance, the distribution unit 35 distributes the sound information 142 to the terminal device 10. Here, the predetermined distance is set to a distance that corresponds to a duration in which before the user 11 arrives at the destination while moving at a current moving speed, the pre-downloading of the sound information 142 by the terminal device 10 can be completed.

Furthermore, the distribution unit 35 divides the sound information 142 according to the distance from the user 11 to the destination and distributes the divided sound information 142 to the terminal device 10. For example, when the distance from the user 11 to the destination is relatively long, the distribution unit 35 divides the sound information 142 into a larger number of divisions, as compared with a case where the distance is relatively short, and distributes the sound information 142. Furthermore, the distribution unit 35 divides the sound information 142 according to the data size of the sound information 142 and distributes the divided sound information to the terminal device 10.

When a predetermined erasing condition is satisfied after distributing the sound information 142, the distribution unit 35 outputs an erase instruction to erase the pre-downloaded sound information 142 to the terminal device 10. For example, when the sequence transfer probability Pn, which indicates the probability that the user 11 may go to the destination for which the position information is associated with the sound information 142, is equal to or less than a threshold, the distribution unit 35 causes the terminal device 10 to erase the pre-downloaded sound information 142.

Furthermore, even if the sequence transfer probability Pn, which indicates the probability that the user 11 may go to the destination for which the position information is associated with the sound information 142, is equal to or less than the threshold, the distribution unit 35 can also cause the terminal device 10 to hold the pre-downloaded sound information 142 until the destination is out of a predetermined range around the user 11. When the destination is out of the predetermined range around the user 11, the pre-downloaded sound information 142 associated with the destination is caused to be erased by the distribution unit 35.

[1.5. Specific Example of Method for Selection of Content According to First Embodiment]

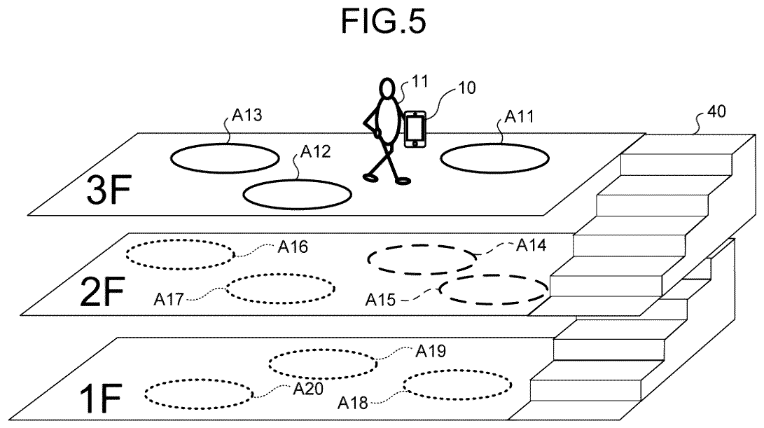

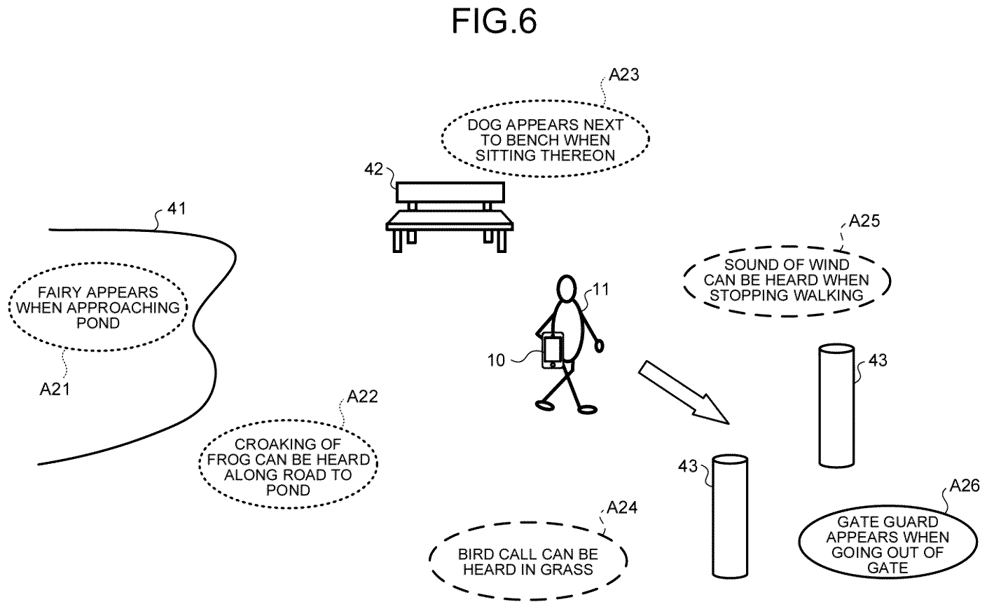

FIGS. 5 and 6 are each a diagram illustrating a specific example of a method for selection of content according to the first embodiment. FIG. 5 illustrates an example of the selection method based on floor position information. FIG. 6 illustrates an example of a selection method in an open world of a game in which an AR image and the sound information 142 are superimposed on the real world.

As illustrated in FIG. 5, for example, when the user 11 who carries the terminal device 10 is on the third floor, the information processing apparatus 1 determines that destinations A11, A12, and A13 on the third floor are sequences each having a high possibility of transfer, on the basis of the position and moving direction of the user 11.

At this time, the information processing apparatus 1 determines destinations A14 and A15 near stairs 40 on the second floor as sequences each having a slightly high possibility of transfer, on the basis of the position and moving direction of the user 11. Meanwhile, the information processing apparatus 1 determines that destinations A16 and A17 far from the stairs 40 on the second floor and objects A18, A19, and A20 on the first floor are sequences each having a low possibility of transfer, on the basis of the position and moving direction of the user 11.

Furthermore, as illustrated in FIG. 6, the user 11 who carries the terminal device 10 is moving in the open world in which a pond 41, a bench 42, and a gate 43 are arranged. In the pond 41, a destination A21 where a fairy appears when approaching the pond 41 is arranged. Near the pond 41, a destination A22 where croaking of a frog can be heard along a road to the pond 41 is arranged. Near the bench 42, a destination A23 where a dog appears next to the bench 42 when sitting thereon.

Near the gate 43, a destination A24 where a bird call can be heard in the grass and a destination A25 where sound of wind can be heard when stopping walking are arranged. A destination A26 where a gate guard appears when going out of the gate 43 is provided at a place outside the gate 43.

At the time point illustrated in FIG. 6, the pond 41 and the bench 42 are positioned in back of the user 11. Therefore, the information processing apparatus 1 determines that the destinations A21, A22, and A23 positioned in back of the user 11 are sequences having a low possibility of transfer, on the basis of the position and moving direction of the user 11.

Furthermore, the destinations A24 and A25 are positioned in front of the user 11, but the user 11 is moving in a direction from the gate 43 to the outside as indicated by a white arrow, and thus the information processing apparatus 1 determines that the destinations A24 and A25 are sequence having a slightly high possibility of transfer, on the basis of the position and moving direction of the user 11. Then, the information processing apparatus 1 determines that the destination A26 positioned ahead in the traveling direction of the user is a sequence having a high possibility of transfer, on the basis of the position and moving direction of the user 11.

[1.6. Exemplary Distribution of Content]

Distribution of the sound information 142 to each of the terminal devices 10 by the information processing apparatus 1 has been described above, but this is an example. For example, in a case where a group of a plurality of users receives service of providing the sound information 142, the information processing apparatus 1 can change a method of distributing the sound information.

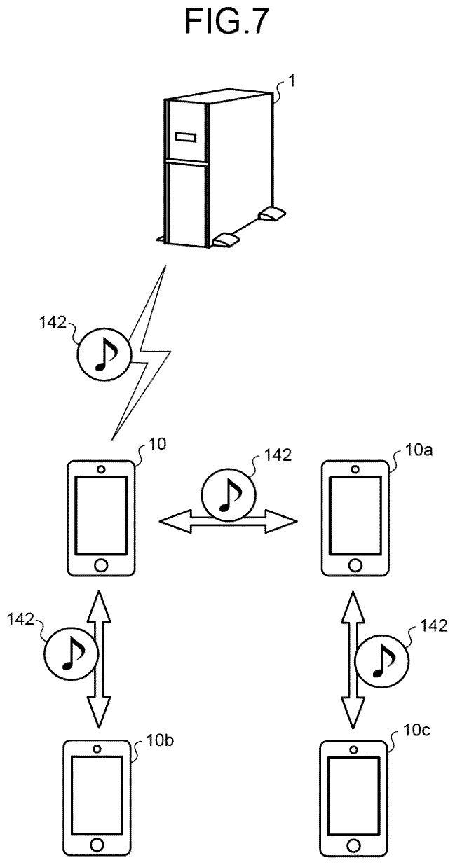

FIG. 7 is a diagram illustrating exemplary distribution of the content according to the first embodiment. As illustrated in FIG. 7, in some cases, the information processing apparatus 1 distributes the sound information 142 to terminal devices 10, 10a, 10b, and 10c carried by each of four users.

At that time, the communication speed between the terminal devices 10, 10a, 10b, and 10c is faster than the communication speed with the terminal device 10, in some cases. In such a case, the information processing apparatus 1 distributes the sound information 142 to one terminal device 10 so that the sound information 142 is caused to be sequentially transferred and pre-downloaded from the terminal device 10 to the other terminal devices 10a, 10b, and 10c.

[1.7. Processing Performed by Information Processing Apparatus According to First Embodiment]

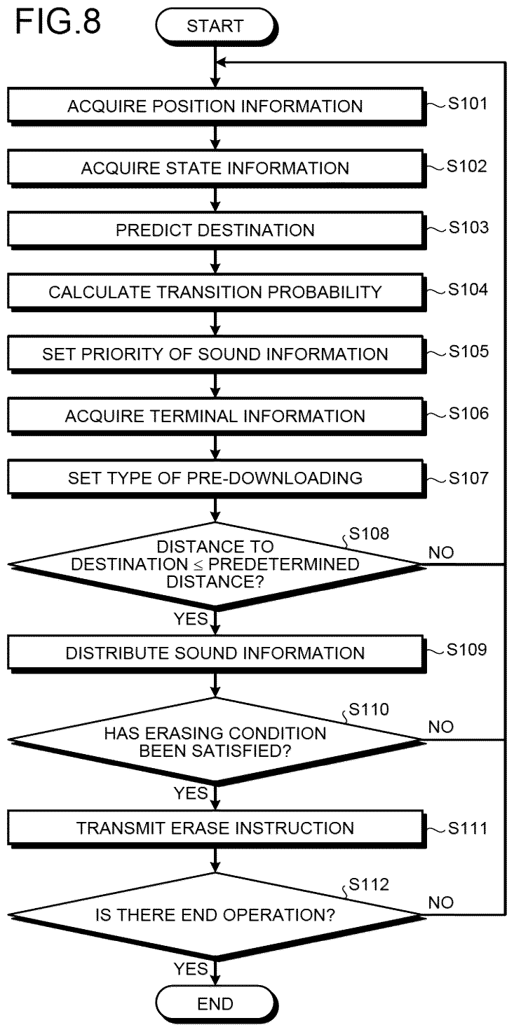

FIG. 8 is a flowchart illustrating processing performed by the information processing apparatus according to the first embodiment. As illustrated in FIG. 8, first, the information processing apparatus 1 acquires the position information of the terminal device 10 (Step S101), and acquires the state information of the terminal device 10 (Step S102).

Subsequently, the information processing apparatus 1 predicts the destination as the destination of the user 11, on the basis of the position information and the state information (Step S103). Thereafter, the information processing apparatus 1 calculates the transition probability (sequence transfer probability Pn) indicating that the user 11 may go to the predicted destination (Step S104). Then, the information processing apparatus 1 sets the priority of the sound information to be distributed to the terminal device 10, according to the calculated probability (Step S105).

Subsequently, the information processing apparatus 1 acquires the terminal information 143 from the terminal device 10 (Step S106), and sets the type of pre-downloading according to the terminal information 143 (Step S107). Thereafter, the information processing apparatus 1 determines whether the distance from the user 11 to the predicted destination is equal to or less than the predetermined distance (Step S108).

Then, when the information processing apparatus 1 determines that the distance from the user 11 to the predicted destination is not equal to or less than the predetermined distance (Step S108, No), the process proceeds to Step S101. Furthermore, when it is determined that the distance from the user 11 to the predicted destination is equal to or less than the predetermined distance (Step S108, Yes), the information processing apparatus 1 distributes the sound information 142 associated with the predicted destination, to the terminal device 10 and causes the terminal device 10 to pre-download the sound information 142 (Step S109).

Thereafter, the information processing apparatus 1 determines whether the erasing condition is satisfied (Step S110). When the information processing apparatus 1 determines that the erasing condition is not satisfied (Step S110, No), the process proceeds to Step S101. When it is determined that the erasing condition is satisfied (Step S110, Yes), the information processing apparatus 1 transmits the erase instruction to the terminal device 10 (Step S111).

Thereafter, the information processing apparatus 1 determines whether the terminal device 10 receives an end operation (Step S112). When the information processing apparatus 1 determines that no end operation is received (Step S112, No), the process proceeds to Step S101. Furthermore, when the information processing apparatus 1 determines that the end operation is received (Step S112, Yes), the process is finished.

### 2. Second Embodiment

[2.1. Configuration of Information Processing Apparatus According to Second Embodiment]

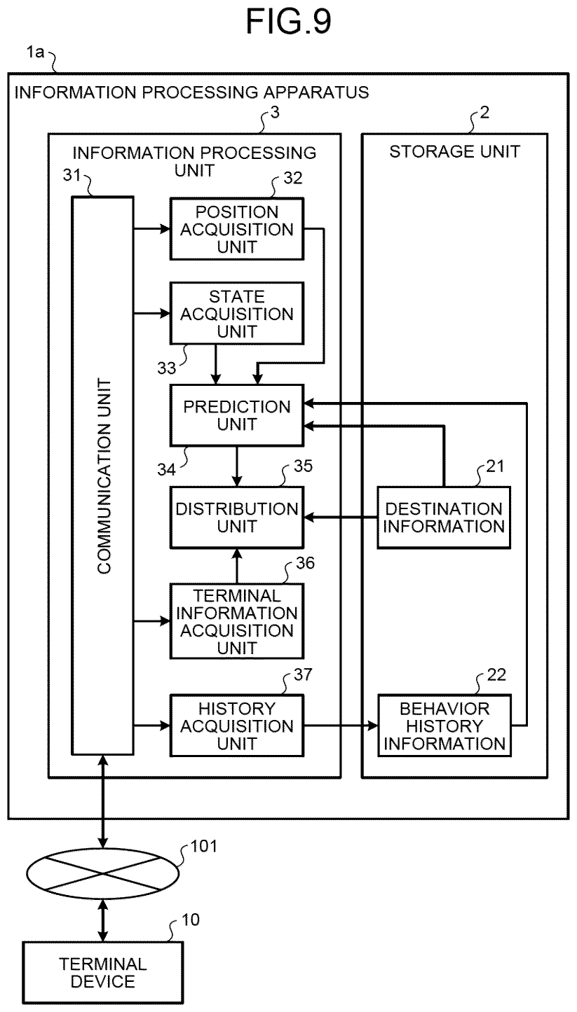

FIG. 9 is a diagram illustrating an exemplary configuration of an information processing apparatus according to a second embodiment. As illustrated in FIG. 9, an information processing apparatus 1a according to the second embodiment is different from the information processing apparatus 1 according to the first embodiment in that the information processing unit 3 further includes a history acquisition unit 37 and the storage unit 2 further stores behavior history information 22.

Therefore, configurations related to the history acquisition unit 37 and the behavior history information 22 will be described here, other configurations are similar to those of the information processing apparatus 1 according to the first embodiment, and the redundant description thereof will be omitted.

A behavior history acquisition unit 27 acquires the behavior history information 22 of a plurality of users from terminal devices of the plurality of users and causes the storage unit 2 to store the acquired information. Here, the plurality of users may be a group of users having received a service from the information processing system 100, or may be a plurality of users who has individually received the service of the information processing system 100.

The behavior history information 22 includes sequence transfer histories of the plurality of users and sequence transfer statistics. The sequence transfer history is history information indicating an order of vising the destinations of each of the plurality of users. Each of the sequence transfer statistics is information indicating a statistic of which destination the user has moved to next from each destination.

The prediction unit 34 predicts a destination as the destination of the user 11, on the basis of the behavior history information 22, in addition to the destination information 21 and the position information and state information of the user 11 to whom the sound information 142 is to be distributed.

[2.2. Operations of Information Processing Apparatus According to Second Embodiment]

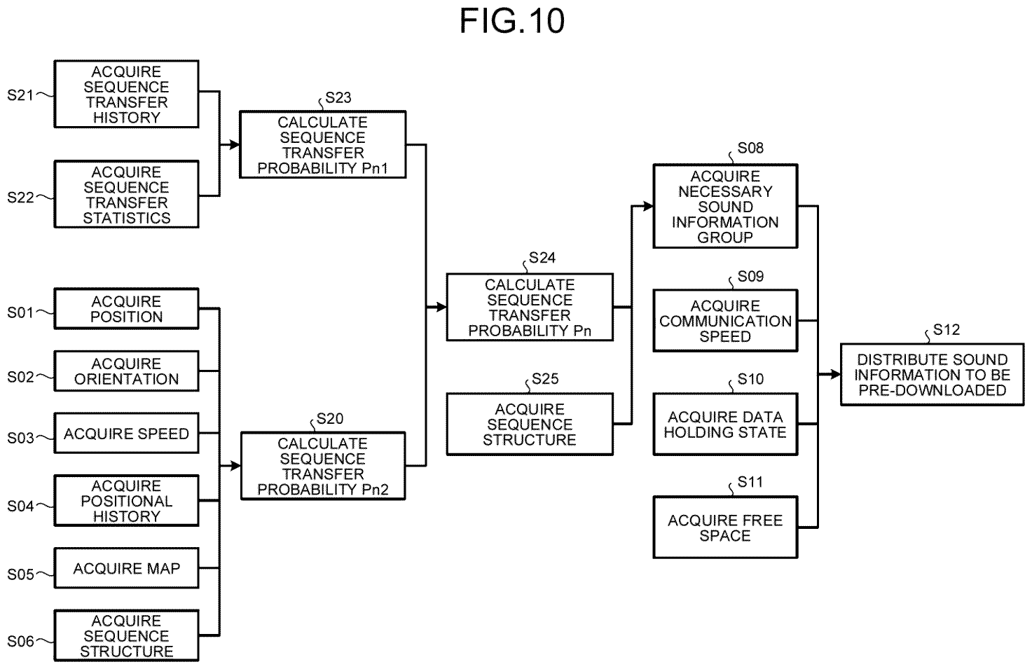

FIG. 10 is a diagram illustrating operations of the information processing apparatus according to the second embodiment. The operations of Steps S01 to S06 illustrated in FIG. 10 are the same as the operations of Steps S01 to S06 illustrated in FIG. 4. Furthermore, the operation of Step S20 illustrated in FIG. 10 is the same as the operation of Step S07 illustrated in FIG. 4. In other words, a sequence transfer probability Pn2 illustrated in FIG. 10 is the same as the sequence transfer probability Pn illustrated in FIG. 4. Therefore, redundant description of the operations of Steps S01 to S06, and S20 will be omitted here.

In addition to the operations of Steps S01 to S06 and S20, the information processing apparatus 1a acquires the sequence transfer history by using the history acquisition unit 37 (Step S21) and acquires the sequence transfer statistics (Step S22). Then, the prediction unit 34 calculates a sequence transfer probability Pn1 of the user 11 to whom the sound information 142 is to be distributed this time, on the basis of the sequence transfer history and the sequence transfer statistics (Step S23). In other words, the prediction unit 34 predicts the destination as the destination of the user 11, on the basis of the behavior history and statistics of a plurality of other users who were at the place in the past from the place where the user 11 to whom the sound information 142 is to be distributed this time is present.

Thereafter, the prediction unit 34 calculates the final sequence transfer probability Pn based on the sequence transfer probability Pn1 and the sequence transfer probability Pn2 (Step S24). For example, the sequence transfer probability Pn is calculated according to the following Formula (1).

pn=C×pn1+(1−C)×pn2 (1)
(C is a weighting coefficient)

Furthermore, the prediction unit 34 may calculate the sequence transfer probability Pn according to the following Formula (2) that is a calculation formula for normalization of the product.

Pn=Pn1×Pn2/Σ(Pk1×Pk2) (2)

Furthermore, the prediction unit 34 may calculate the sequence transfer probability Pn according to the following Formula (3) that is a calculation formula for normalization of the sum.

Pn=Pn1+cPn2/Σ(Pk1+cPk2) (3)

Note that when a positioning accuracy in the position of the user is high, it is desirable to adopt Formula (2) which is the calculation formula for normalization of the product described above. On the other hand, when the positioning accuracy in the position of the user is low, it is desirable to adopt Formula (3) which is the calculation formula for normalization of the sum described above, because an error is doubled due to the calculation formula for normalization of the product.

Thereafter, the information processing apparatus 1a acquires the sequence structure (Step S25), refers to the sequence structure, performs the operations of Steps S08 to S12, as in the information processing apparatus 1 according to the first embodiment, and distributes the sound information 142 to be pre-downloaded, to the terminal device 10, according to the set type of pre-downloading and causes the terminal device 10 to pre-download (Step S12).

[2.3. Processing Performed by Information Processing Apparatus According to Second Embodiment]

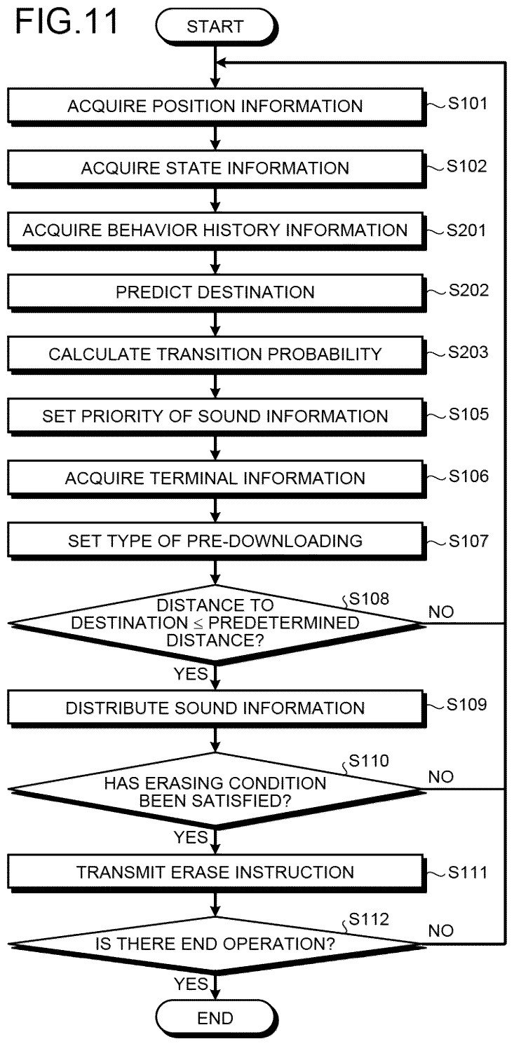

FIG. 11 is a flowchart illustrating processing performed by the information processing apparatus according to the second embodiment. The processing of Steps S101, S102, and S105 to S112 illustrated in FIG. 11 is the same as the processing of Steps S101, S102, and S105 to S112 illustrated in FIG. 8 performed by the information processing apparatus 1 according to the first embodiment.

Therefore, here, the processing of Steps S201 to S203 illustrated in FIG. 11 will be described, and redundant description of other processing will be omitted here. In Step S201, the information processing apparatus 1a acquires the behavior history information of the plurality of users. Then, the information processing apparatus 1a predicts the destination as the destination of the user, on the basis of the position information and state information of the user 11 and the behavior history information of the plurality of users (Step S202).

Subsequently, the information processing apparatus 1a calculates the transition probability (sequence transfer probability Pn) (Step S203). At this time, the information processing apparatus 1a calculates the sequence transfer probability Pn1 on the basis of the behavior history information of the plurality of users, and calculates the sequence transfer probability Pn2 on the basis of the position information and state information of the user 11.

Then, the final sequence transfer probability Pn is calculated by using any of the above Formulas (1) to (3). Then, the information processing apparatus 1a performs Steps S105 to S112, similarly to the information processing apparatus 1 according to the first embodiment.

[3. Effects]

The information processing apparatus 1 includes the storage unit 2, the position acquisition unit 32, the state acquisition unit 33, the state acquisition unit 33, and the distribution unit 35. The storage unit 2 stores the destination information 21 in which the position information of the destination is associated with the content provided from the terminal device 10 of the user 11 to the user 11 at the destination. The position acquisition unit 32 acquires the position information of the user 11 from the terminal device 10. The state acquisition unit 33 acquires the state information of the user 11 from the terminal device 10. The state acquisition unit 33 predicts the destination as the destination of the user 11, on the basis of the position information of the user 11 and the state information of the user 11. Before the user 11 arrives at the predicted destination, the distribution unit 35 distributes the content to be provided to the user 11 at the predicted destination, to the terminal device 10 and causes the terminal device 10 to pre-download the content. As described above, the information processing apparatus 1 uses the state information of the user 11 as a predictor, in addition to the position information of the user 11, and therefore, it is possible to predict the destination as the destination of the user 11 highly accurately, as compared with use of only the position information of the user 11, as the predictor. Therefore, the information processing apparatus 1 is configured to accurately select the information necessary for the user 11 and provide the information to the user 11 to reduce the amount of data for communication.

The information processing apparatus 1a includes the history acquisition unit 37. The history acquisition unit 37 acquires the behavior history information 22 of the plurality of users. The state acquisition unit 33 predicts the destination as the destination of the user 11 on the basis of the position information of the user 11 and the behavior history information 22 of the plurality of users. As described above, the information processing apparatus 1a uses the behavior history information 22 of the plurality of users, as the predictor, in addition to the position information and state information of the user 11, and therefore, it is possible to predict the destination as the destination of the user 11 highly accurately. Therefore, the information processing apparatus 1a is configured to accurately select the information necessary for the user 11 and provide the information to the user 11 to reduce the amount of data for communication.

The state acquisition unit 33 predicts the plurality of destinations as the destinations of the user 11, and calculates the probability that the user 11 may go to each destination, for each of the plurality of destinations. The distribution unit 35 sets the priority of the content to be distributed to the terminal device 10 according to the probability. This configuration makes it possible for the information processing apparatus 1 to cause the terminal device 10 of the user 11 to preferentially pre-download the content associated with the destination to which the user 11 is more likely to go.

When the probability that the user 11 may go to the destination for which the position information is associated with the content is equal to or less than the threshold, the distribution unit 35 causes the terminal device 10 to erase the pre-downloaded content. This configuration makes it possible for the information processing apparatus 1 to remove unnecessary content from the storage unit 14 of the terminal device 10 to increase the free space of the storage unit 14, and the content required thereafter can be pre-downloaded into the available storage area.

Even if the probability that the user 11 may go to the destination for which the position information is associated with the content is equal to or less than the threshold, the distribution unit 35 causes the terminal device 10 to hold the pre-downloaded content until the destination is out of the predetermined range around the user 11. Therefore, even if the user 11 goes to a destination that is positioned near the user 11 and that is determined that the user 11 is unlikely to go, the information processing apparatus 1 can provide the content associated with the destination in real time.

The distribution unit 35 sets the type of pre-downloading by the terminal device 10, according to the probability. This configuration makes it possible for the information processing apparatus 1 to set an optimal type of pre-downloading, according to the probability that the user 11 may go to each destination.

The information processing apparatus 1 includes the terminal information acquisition unit 36. The terminal information acquisition unit 36 acquires the terminal information 143 about the terminal device 10, from the terminal device 10. The distribution unit 35 sets the type of pre-downloading by the terminal device 10, according to the terminal information 143. This configuration makes it possible for the information processing apparatus 1 to set an optimal type of pre-downloading, according to, for example, the information indicating a state of the communication speed of the terminal device 10, the information indicating a state of holding the sound information 142, the information indicating the free space of the storage unit 14, and the like

When the communication speed between the terminal devices is faster than the communication speed with the terminal device 10, the distribution unit 35 distributes the content to one terminal device 10 so that the content is caused to be sequentially transferred and pre-downloaded from the one terminal device 10 to the other terminal devices. This configuration makes it possible for the information processing apparatus 1 to pre-download the content to the plurality of terminal devices more quickly, as compared with distribution of the content to the respective terminal devices.

The distribution unit 35 sets, as the type of pre-downloading, at least one of the communication speed at which the content is caused to be pre-downloaded and the quality of the content. Therefore, the information processing apparatus 1 is operable to distribute the content at an appropriate communication speed or distribute the content of an appropriate quality, according to the performance or state of the terminal device 10.

When the distance from the user 11 to the destination is equal to or less than the predetermined distance, the distribution unit 35 distributes the content to the terminal device 10. Therefore, when the user 11 arrives at the destination, the information processing apparatus 1 can cause the terminal device 10 to provide the user 11 with the content without making the user wait.

Furthermore, the distribution unit 35 divides the content according to the distance from the user 11 to the destination and distributes the divided content to the terminal device 10. Therefore, for example, the information processing apparatus 1 divides the content into a larger number of divisions as the distance from the user 11 to the destination is long, and this configuration makes it possible to suppress useless content from being pre-downloaded when the user 11 does not go to the predicted destination.

The distribution unit 35 divides the content according to the data size of the content and distributes the content to the terminal device 10. Therefore, for example, the information processing apparatus 1 divides the content into a larger number of divisions as the data size of the content is larger, and this configuration makes it possible to suppress useless content from being pre-downloaded when the user 11 does not go to the predicted destination.

The information processing system 100 includes the information processing apparatus 1 and the terminal device 10. The information processing apparatus 1 includes the storage unit 2, the position acquisition unit 32, the state acquisition unit 33, the state acquisition unit 33, and the distribution unit 35. The storage unit 2 stores the destination information 21 in which the position information of the destination is associated with the content provided from the terminal device 10 of the user 11 to the user 11 at the destination. The position acquisition unit 32 acquires the position information of the user 11 from the terminal device 10. The state acquisition unit 33 acquires the state information of the user 11 from the terminal device 10. The state acquisition unit 33 predicts the destination as the destination of the user 11, on the basis of the position information of the user 11 and the state information of the user 11. Before the user 11 arrives at the predicted destination, the distribution unit 35 distributes the content to be provided to the user 11 at the predicted destination, to the terminal device 10 and causes the terminal device 10 to pre-download the content. As described above, the information processing system 100 uses the state information of the user 11 as the predictor, in addition to the position information of the user 11, and therefore, it is possible to predict the destination as the destination of the user 11 highly accurately, as compared with use of only the position information of the user 11, as the predictor. Therefore, the information processing system 100 is configured to accurately select the information necessary for the user 11 and provide the information to the user 11 to reduce the amount of data for communication.

The information processing method according to the present disclosure includes a processor storing the destination information 21 in which the position information of the destination is associated with the content provided from the terminal device 10 of the user 11 to the user 11 at the destination, acquiring the position information of the user 11 from the terminal device 10, acquiring the state information of the user 11 from the terminal device 10, predicting the destination as the destination of the user 11 on the basis of the position information and the state information, and distributing the content to be provided to the user 11 at the predicted destination to the terminal device 10 to cause the terminal device 10 to pre-download the content before the user 11 arrives at the predicted destination. As described above, the information processing method uses the state information of the user 11 as the predictor, in addition to the position information of the user 11, and therefore, it is possible to predict the destination as the destination of the user 11 highly accurately, as compared with use of only the position information of the user 11, as the predictor. Therefore, the information processing method is configured to accurately select the information necessary for the user 11 and provide the information to the user 11 to reduce the amount of data for communication.

Furthermore, the information processing system 100 according to the present disclosure has the following effects. For example, the information processing apparatus 1 causes the terminal device to appropriately pre-download the sound information 142, reducing the waiting time from the transition of the user 11 to the reproduction of the sound information 142, and creating a responsive content experience.

Furthermore, the information processing system 100 can arrange a content package (large-volume data such as sound data, map, and scenario sequence) of SoundAR entertainment in a cloud. This configuration makes it possible for the terminal device 10 to download only necessary data if necessary. Therefore, the user 11 does not need to download the entire package before starting the experience, and a waiting time to download the content before starting the experience can be eliminated.

Furthermore, the terminal device 10 is configured to pre-download only the necessary amount of data without uselessly requiring the storage size. This configuration makes it possible for the user 11 to have an experience even on an inexpensive mobile terminal or IoT terminal that has less available storage.

Furthermore, the information processing apparatus 1 is configured to accurately select the content to be pre-downloaded to reduce a communication volume for each user 11. Then, the information processing apparatus 1 is configured to accurately select the content to be pre-downloaded to reduce a total communication volume in an event venue and increase the number of people who simultaneously have the same experience for each communication band.

In addition, estimating the destination in consideration of the scenario sequence makes it possible for the information processing apparatus 1 to reject a sequence having a low possibility of transfer in advance to reduce the possibility of erroneously pre-downloading unnecessary sound information 142.

Performing estimation in consideration of the movement, position, and orientation of the user 11 makes it possible for the information processing apparatus 1 to accurately estimate and select a transition destination sequence even when “the scenario sequence has a wide range of progress” which is often occurs when a scenario progresses in the real world.

Note that the effects described herein are merely examples and are not intended to restrict the present disclosure, and other effects may be provided.

Note that the present technology can also have the following configurations.
(1)
An information processing apparatus including:
a storage unit that stores destination information in which position information of a destination is associated with content provided from a terminal device of a user to the user at the destination;
a position acquisition unit that acquires position information of the user from the terminal device;
a state acquisition unit that acquires state information of the user from the terminal device;
a prediction unit that predicts the destination as a destination of the user, based on the position information of the user and the state information of the user; and a distribution unit that distributes the content to be provided to the user at the destination predicted to the terminal device and causes the terminal device to pre-download the content, before the user arrives at the destination predicted.
(2)
The information processing apparatus according to (1) described above, further including
a history acquisition unit that acquires behavior history information of a plurality of users,
in which the prediction unit
predicts the destination as the destination of the user, based on the position information of the user and the behavior history information.
(3)
The information processing apparatus according to (1) or (2) described above, in which
the prediction unit
predicts a plurality of the destinations as the destinations of the user and calculates a probability that the user may go to each of the plurality of destinations, for each of the destinations, and
the distribution unit
sets a priority of the content to be distributed to the terminal device according to the probability.
(4)
The information processing apparatus according to (3) described above, in which
the distribution unit
causes the terminal device to erase the pre-downloaded content, when the probability that the user may go to the destination for which the position information is associated with the content is equal to or less than a threshold.
(5)
The information processing apparatus according to (3) described above, in which
the distribution unit
causes the terminal device to hold the pre-downloaded content until the destination is out of a predetermined range around the user, even when the probability that the user may go to the destination for which the position information is associated with the content is equal to or less than a threshold.
(6)
The information processing apparatus according to any one of (3) to (5) described above, in which
the distribution unit
sets a type of pre-downloading by the terminal device according to the probability.
(7)
The information processing apparatus according to any one of (3) to (6) described above, further including
a terminal information acquisition unit that acquires terminal information about the terminal device, from the terminal device,
in which the distribution unit
sets a type of pre-downloading by the terminal device according to the terminal information.
(8)
The information processing apparatus according to (7) described above, in which
when a communication speed between the terminal devices is faster than a communication speed with the terminal device, the distribution unit distributes the content to one terminal device in order that the content is caused to be sequentially transferred and pre-downloaded from the one terminal device to the other terminal devices.
(9)
The information processing apparatus according to any one of (6) to (8) described above, in which
the distribution unit
sets, as a type of pre-downloading, at least one of a communication speed at which the content is caused to be pre-downloaded and quality of the content.
(10)
The information processing apparatus according to any one of (1) to (9) described above, in which
the distribution unit
distributes content to the terminal device when a distance from the user to the destination is equal to or less than a predetermined distance.
(11)
The information processing apparatus according to any one of (1) to (10) described above, in which
the distribution unit
divides the content according to a distance from the user to the destination and distributes the divided content to the terminal device.
(12)
The information processing apparatus according to any one of (1) to (10) described above, in which
the distribution unit
divides the content according to a data size of the content and distributes the divided content to the terminal device.
(13)
An information processing system including:
an information processing apparatus including:
a storage unit that stores destination information in which position information of a destination is associated with content provided from a terminal device of a user to the user at the destination;
a position acquisition unit that acquires position information of the user from the terminal device;
a state acquisition unit that acquires state information of the user from the terminal device;
a prediction unit that predicts the destination as a destination of the user, based on the position information and the state information; and
a distribution unit that distributes the content to be provided to the user at the destination predicted to the terminal device and causes the terminal device to pre-download the content, before the user arrives at the destination predicted; and
the terminal device.
(14)
An information processing method including:
a processor
storing destination information in which position information of a destination is associated with content provided from a terminal device of a user to the user at the destination;
acquiring position information of the user from the terminal device;
acquiring state information of the user from the terminal device;
predicting the destination as a destination of the user, based on the position information and the state information; and
distributing the content to be provided to the user at the destination predicted to the terminal device and causing the terminal device to pre-download the content, before the user arrives at the destination predicted.

### REFERENCE SIGNS LIST

100 INFORMATION PROCESSING SYSTEM
101 COMMUNICATION NETWORK
10 TERMINAL DEVICE
11 USER
12 SOUND OUTPUT DEVICE
13 SENSOR MODULE
14 STORAGE UNIT
141 MAP INFORMATION
142 SOUND INFORMATION
143 TERMINAL INFORMATION
15 INFORMATION PROCESSING UNIT
151 SOUND REPRODUCING UNIT
152 RECORDING UNIT
153 COMMUNICATION UNIT
1 INFORMATION PROCESSING APPARATUS
2 STORAGE UNIT
21 DESTINATION INFORMATION
22 BEHAVIOR HISTORY INFORMATION
3 INFORMATION PROCESSING UNIT
31 COMMUNICATION UNIT
32 POSITION ACQUISITION UNIT
33 STATE ACQUISITION UNIT
34 PREDICTION UNIT
35 DISTRIBUTION UNIT
36 TERMINAL INFORMATION ACQUISITION UNIT
37 HISTORY ACQUISITION UNIT

1. An information processing apparatus comprising:
a storage unit that stores destination information in which position information of a destination is associated with content provided from a terminal device of a user to the user at the destination;
a position acquisition unit that acquires position information of the user from the terminal device;
a state acquisition unit that acquires state information of the user from the terminal device;
a prediction unit that predicts the destination as a destination of the user, based on the position information of the user and the state information of the user; and
a distribution unit that distributes the content to be provided to the user at the destination predicted to the terminal device and causes the terminal device to pre-download the content, before the user arrives at the destination predicted.

2. The information processing apparatus according to claim 1, further comprising
a history acquisition unit that acquires behavior history information of a plurality of users,
wherein the prediction unit
predicts the destination as the destination of the user, based on the position information of the user and the behavior history information.

3. The information processing apparatus according to claim 1, wherein
the prediction unit
predicts a plurality of the destinations as the destinations of the user and calculates a probability that the user may go to each of the plurality of destinations, for each of the destinations, and
the distribution unit
sets a priority of the content to be distributed to the terminal device according to the probability.

4. The information processing apparatus according to claim 3, wherein
the distribution unit
causes the terminal device to erase the pre-downloaded content, when the probability that the user may go to the destination for which the position information is associated with the content is equal to or less than a threshold.

5. The information processing apparatus according to claim 3, wherein
the distribution unit
causes the terminal device to hold the pre-downloaded content until the destination is out of a predetermined range around the user, even when the probability that the user may go to the destination for which the position information is associated with the content is equal to or less than a threshold.

6. The information processing apparatus according to claim 3, wherein
the distribution unit
sets a type of pre-downloading by the terminal device according to the probability.

7. The information processing apparatus according to claim 3, further comprising
a terminal information acquisition unit that acquires terminal information about the terminal device, from the terminal device,
wherein the distribution unit
sets a type of pre-downloading by the terminal device according to the terminal information.

8. The information processing apparatus according to claim 7, wherein
when a communication speed between the terminal devices is faster than a communication speed with the terminal device, the distribution unit distributes the content to one terminal device in order that the content is caused to be sequentially transferred and pre-downloaded from the one terminal device to the other terminal devices.

9. The information processing apparatus according to claim 6, wherein
the distribution unit
sets, as a type of pre-downloading, at least one of a communication speed at which the content is caused to be pre-downloaded and quality of the content.

10. The information processing apparatus according to claim 1, wherein
the distribution unit
distributes content to the terminal device when a distance from the user to the destination is equal to or less than a predetermined distance.

11. The information processing apparatus according to claim 1, wherein
the distribution unit
divides the content according to a distance from the user to the destination and distributes the divided content to the terminal device.

12. The information processing apparatus according to claim 1, wherein
the distribution unit
divides the content according to a data size of the content and distributes the divided content to the terminal device.

13. An information processing system comprising:
an information processing apparatus comprising:
a storage unit that stores destination information in which position information of a destination is associated with content provided from a terminal device of a user to the user at the destination;
a position acquisition unit that acquires position information of the user from the terminal device;
a state acquisition unit that acquires state information of the user from the terminal device;
a prediction unit that predicts the destination as a destination of the user, based on the position information and the state information; and
a distribution unit that distributes the content to be provided to the user at the destination predicted to the terminal device and causes the terminal device to pre-download the content, before the user arrives at the destination predicted; and
the terminal device.

14. An information processing method comprising:
a processor
storing destination information in which position information of a destination is associated with content provided from a terminal device of a user to the user at the destination;
acquiring position information of the user from the terminal device;
acquiring state information of the user from the terminal device;
predicting the destination as a destination of the user, based on the position information and the state information; and
distributing the content to be provided to the user at the destination predicted to the terminal device and causing the terminal device to pre-download the content, before the user arrives at the destination predicted.
